(19) United States
(12) Patent Application Publication
(10) Pub. No.: US 2006/0192611 A1
(43) Pub. Date: Aug. 31, 2006

(54) BODY-BIASED ENHANCED PRECISION CURRENT MIRROR

(75) Inventors: Anthony R. Bonaccio, Shelburne, VT (US); Hayden C. Cranford JR., Cary, NC (US)

Correspondence Address: IBM MICROELECTRONICS;INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, VT (US)

(21) Appl. No.: 10/906,628

(22) Filed: Feb. 28, 2005

(51) Int. Cl. G05F 1/10

(52) U.S. Cl. 327/543

(57) ABSTRACT

A body-biased enhanced current mirror reference circuit is disclosed wherein the body bias voltage of a current mirror device is varied to adjust its threshold voltage. Both the drain and body potentials of a replica mirror transistor are controlled to selected values. The drain is set to an expected DC voltage output of an NFET current mirror device. The body potential is set to a maximum desired value to prevent forward biasing of the body-to-diffusion junction(s) of one or more current mirror devices, which is accomplished by a feedback control circuit. A low-frequency, low-precision op amp drives the gate of a replica load device so that the body of the replica NFET current mirror device is set to a maximum bias voltage. The maximum bias voltage is also used to bias the body of a diode connected NMOS reference transistor, so that the current in the NFET current mirror device will be approximately equal to the current in the diode-connected NMOS reference. An auxiliary NFET current mirror device may be added to the body-biased enhanced current mirror circuit with the body connected to ground as in the unmodified current mirror to negate a non-monotonicity of the current output.

### FIELD OF THE INVENTION

The field of the invention relates to a current reference integrated circuit and more particularly to a current reference circuit incorporating a biasing scheme to modulate the threshold voltage of an output device of a current mirror to compensate for the effect of a change in output voltage on the output current.

### BACKGROUND OF THE INVENTION

A MOSFET current mirror is an essential component of integrated circuit amplifiers that is used to implement current sources for biasing and may also operate as an active load. The MOSFET current mirror typically includes at least two devices configured such that the ratio of currents through each device remains largely constant. The current ratio is controlled by the physical geometry of the transistors, which enables the current flowing through a larger device to be approximated by reference to the current flowing through a smaller device. In this regard, current in the larger device can be measured by a proportional current in the smaller device, thereby “mirroring” the larger current. Such current-mirror sensing techniques offer a wide dynamic range, but are generally limited to low current applications.

A current reference circuit producing a stable output in the presence of fluctuations in an input power supply voltage is useful in analog computation circuits where variables may be expressed as a simple current, a ratio of currents, or a biased reference current. To stabilize the output current, many current reference circuits incorporate some form of feedback control based on a non-linear gain characteristic of the output stage of the current mirror. Often a resistor is used to achieve a non-linear gain by altering the gate to source voltage of a bias transistor in either the input or output stage of the current mirror. The transistors in the input and output stages of a typical current mirror have non-linear diode current versus voltage characteristics that are well matched, thereby producing a gain that is essentially constant over a wide operating voltage range.

However, MOS transistors are rendered imperfect current sources because a voltage applied to the drain—typically the output when the transistor is used as a current source—causes a modulation of the size of the drain-channel depletion region. As the drain voltage increases, the size of the depletion region grows and the effective channel length is decreased. As a result, the drain current increases as well, hence degrading operation of the device as a constant current source. This tendency can be determined from the saturated drain current equation:
I_{d}=½(μₙCₒₓ)·(W_{eff}/L_{eff})·(V_{gs}−Vₜ)²

where I_{d} clearly increases as L_{eff} decreases. In general, L_{eff} is regarded as fixed and another term is added to the equation to account for channel length modulation:
I_{d}=½(μₙCₒₓ)·(W_{eff}/L_{eff)})·(V_{gs}−Vₜ)²·(1+λV_{ds})

that models the dependency of I_{d} on V_{d} as a linear approximation.

There are two prior art approaches in dealing with the undesirable change in drain current associated with modulation of the drain depletion region. One is to simply make the design channel length larger, which lessens the effect of the depletion region modulation. The change in dimension of the depletion region is a fixed function of the drain voltage and drain doping but not of the channel length. This has the effect of reducing the value of λ in equation 2 above and “flattening” the device curves in the saturation region. However, this technique suffers from either an increase in area with the square of the increase in L_{eff} (since W_{eff} needs to increase by the same proportion) or an increase of the voltage bias margin required for the current source to operate properly in the saturation region.

Another technique is to add circuitry to the basic MOS current mirror that will increase the output resistance. There are literally dozens of circuit topologies designed to provide higher output impedance, the simplest and most straightforward of these being to place a common-gate cascode device immediately in series with the drain of the current mirror. This has the effect of isolating the drain of the current mirror from variations in the voltage at the output of the mirror circuit; the drain observes a voltage set only by the cascode gate bias and the cascode gate-to-source voltage, which is a weak function of the current through the device. Unfortunately, this technique has the disadvantage of requiring additional circuit area and an additional voltage drop across the aggregate mirror structure (the mirror and cascode devices) in order for the cascode device to function properly.

Accordingly, a need exists for a current mirror with improved output impedance characteristics that does not present a significant impact to the area and voltage bias margin of the current mirror device.

### SUMMARY OF THE INVENTION

A first aspect of the invention is directed to a technique for increasing the output impedance of a MOS current source without significant penalty in circuit area or increase in operating voltage. A current mirror circuit is disclosed with a body-bias voltage adjustment capability to compensate for the effect of a change in output voltage on the output current. For each instance of the current mirror, this approach has the advantage of requiring no additional margin in operating voltage nor does it consume more circuit area than prior art current mirror designs. In addition, the body-enhanced current mirror provides a stable reference current to output current ratio over a wide operating range.

### BRIEF DESCRIPTION OF THE DRAWINGS

FIG. 1 illustrates a schematic diagram of a body-biased current mirror according to a first embodiment of the invention.

FIG. 2 illustrates a schematic diagram of a body-biased current mirror according to a second embodiment of the invention.

FIG. 3 illustrates a schematic diagram of a replica bias circuit to control the bias of a plurality of the circuits shown in FIG. 2.

FIG. 4 shows a simulation of an output current corresponding to an unmodified current mirror and a body-biased current mirror plotted versus voltage.

FIG. 5 illustrates a schematic of a body-enhanced current mirror circuit according to a third embodiment having at least one current mirror with an auxiliary grounded device.

FIG. 6 plots the output of the body enhanced current mirror exhibiting a non-monotonic current response at the drain terminal of the body enhanced current source.

FIG. 7 plots the output of the body enhanced current mirror with an auxiliary grounded body device exhibiting a near optimal current response at the drain terminal of the body enhanced current source.

### DETAILED DESCRIPTION OF THE PREFERRED EMBODIMENTS

In the following detailed description of embodiments, reference is made to the accompanying drawings which form a part hereof, and in which are shown by way of illustration specific embodiments that are described in sufficient detail to enable those skilled in the art to practice the invention, and it to be understood that other embodiments may be utilized and logical, structural, electrical and other changes may be made without departing from the scope of the present invention.

Just as channel-length modulation is a well known effect that modifies the output current in a MOS current mirror, the body effect in MOSFET technology is known to vary the threshold voltage of a MOS transistor as a function of the transistor's source-to-body potential. In an NMOS transistor, assuming the body potential is held constant, as the source potential increases the device threshold also increases. If the gate-source potential is also fixed, that is, the change in gate voltage corresponds exactly with the change in source voltage, the current in the device decreases because the threshold voltage increases as a result of the body effect. This drain current decrease, if properly adjusted and controlled, can precisely counteract the increase in drain current that would result from an increase in drain voltage. Accordingly, if the drain voltage can be monitored and selectively applied to increase the source-body potential, the output conductance of a current mirror could, in principle, be set to zero, which corresponds to a high impedance output since impedance is inversely proportional to conductance.

For the device serving as the current mirror, the source is typically grounded and the gate is biased at a potential somewhere above the threshold voltage by the “reference” leg of the mirror. Therefore in order to modify the drain current by changing the source-body potential, this invention controls the body potential rather than the source potential. The body of the current mirror device is initially set to some value and then lowered as a function of the output voltage of the mirror device, which is typically imposed by the circuit in which the mirror is used, rather than by the mirror device itself.

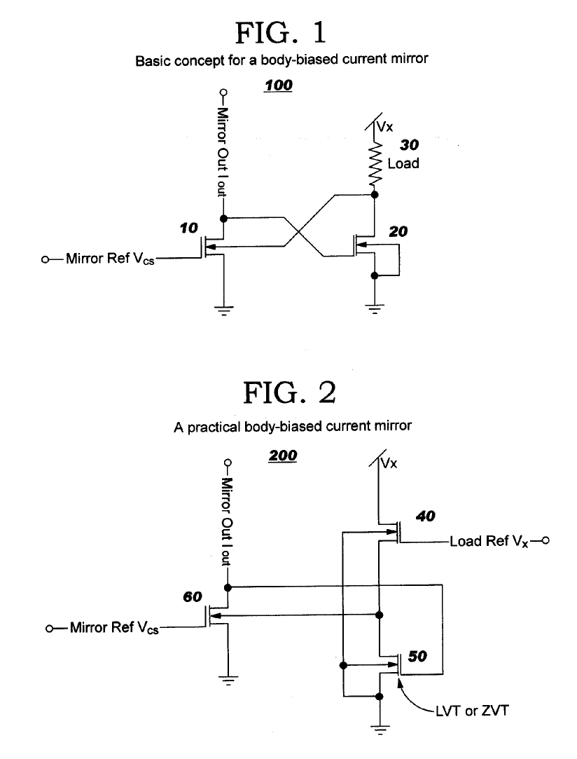

Referring to FIG. 1, a body-biased current mirror 100 according to a first embodiment is shown. The drain voltage of NFET current mirror device 10 is monitored by NFET amplifier 20. If the drain voltage of NFET current mirror device 10 increases, the monitor NFET amplifier 20 pulls down on the body of NFET current mirror device 10 and the tendency of the mirror current to increase is counteracted by the resultant increase in the threshold voltage of NFET current mirror device 10. This increases the apparent output impedance of NFET current mirror device 10.

As shown in FIG. 1, resistor 30 is a load element for the body feedback amplifier 20 that is tied to power supply, Vx. While this circuit topology is conceptually feasible, it has a number of disadvantages, such as requiring significantly increased area and additional processing steps to implement the load as a resistor. In addition, the wire biasing the body feedback amplifier to the supply voltage, Vx has to carry whatever current flows through NFET body feedback amplifier 20, which may become significant if a sufficient number of current mirror devices are instantiated. The increased current in the biasing wire may, in turn, drive an increase in interconnect width and pitch where multiple instances of the mirror device rely on the same biasing current.

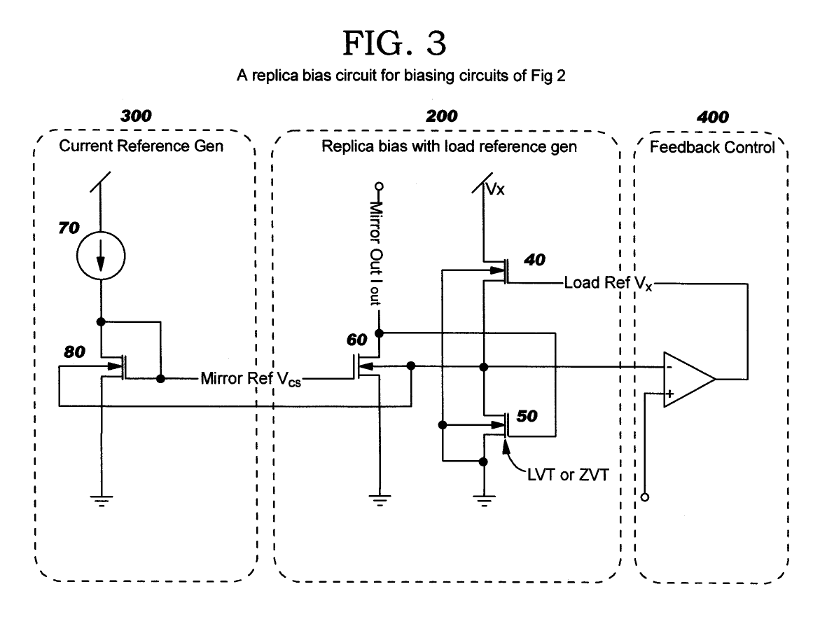

A smaller and therefore more practical implementation for the current mirror is shown in FIG. 2. In this second embodiment, the load element is represented by MOS load transistor 40 with its gate tied to a reference potential, Vx. Although this circuit operates in the same way as the circuit shown in FIG. 1, the MOS transistor provides a more efficient layout together with more easily controlled design parameters. Another difference is that NFET body feedback amplifier 50 is a low-threshold or zero-threshold transistor, which will turn on in response to very low voltages at the drain of NFET current mirror device 60. As such, the voltage requirement for the mirror is not increased to accommodate the body bias network.

A circuit for generating the reference voltage Vx is now disclosed. Since the reference voltage may be commonly applied across a large number of current mirror instances, the circuit used to generate this voltage can be somewhat more complex without adding too much overhead. An exemplar circuit for accomplishing the generation of Vx is shown in FIG. 3.

FIG. 3 is segmented into three circuit instances: current reference generator 300, replica bias circuit with load reference generator 200 and feedback control circuit 400. Current reference generator 300 is a traditional circuit for setting the reference voltage to a current mirror. The input current to be mirrored is forced through diode-connected NMOS reference transistor 80 and the resulting gate voltage, VCS is used to bias the gate of NFET current mirror device 60. Note that replica bias with load reference generator 200 is a repeatable structure, such that multiple instances may be connected to a single current reference generator 300 and a single feedback control 400. For proper circuit operation, however, a minor modification to this structure is required such that the body voltage of reference transistor 80 is controlled to a specific value rather than grounded to compensate for modulation in the depletion region of the current mirror transistor 60 and thereby maintain a constant current.

The second circuit component shown in FIG. 3 is a replica bias circuit with a load reference generator 200 that is preferably instantiated multiple times across the entire integrated circuit. Both the drain and body potentials of replica mirror transistor 60 are controlled to selected values. The drain is set to a DC voltage close to what is expected at the output of NFET current mirror device 60. The body potential is set to a maximum desired value to prevent forward biasing of the body-to-diffusion junction(s) of one or more current mirror devices, which is accomplished by feedback control circuit 400. A low-frequency, low-precision op amp 111 drives the gate of replica load device 50 to a voltage so that the body of replica NFET current mirror device 60 is set to the V_{bmax} potential, which is generated elsewhere on the chip. The V_{bmax} potential preferably tracks the source-body forward-bias voltage. The V_{bmax} potential is also used to bias the body of the diode connected NMOS reference transistor 80, so that the current in NFET current mirror device 60 will be approximately equal to that in the diode-connected NMOS reference transistor 80 since their respective threshold voltages will be equal. This is the reason for biasing the body of the diode-connected NMOS reference transistor 80 in this way. The resulting voltage Vx from feedback control circuit 400 is used in each instance of the mirror along with the mirror reference voltage, Vcs.

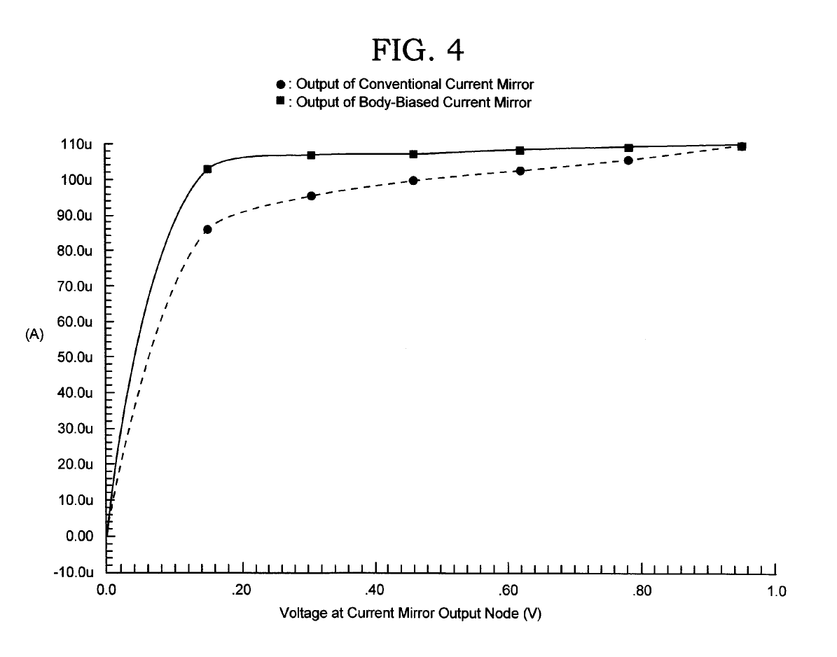

The technique and circuit described has been simulated and the following results have been demonstrated. Referring to FIG. 4, two output waveforms are shown for an unmodified prior art current mirror (dashed curve) and a body-biased current mirror (solid curve) according to the second embodiment. In both circuits the channel length was specified as three times a ground rule minimum for an exemplar 0.09 μm process technology. The drain voltage is swept from 0.2 V to 1.2 V over the period of the analysis. The solid curve is the output of the body-biased enhanced current mirror using the technique and circuit of the present invention. As shown in FIG. 4, the body-bias enhanced current mirror of the present invention exhibits a much flatter response over the specified voltage range than the prior art current mirror.

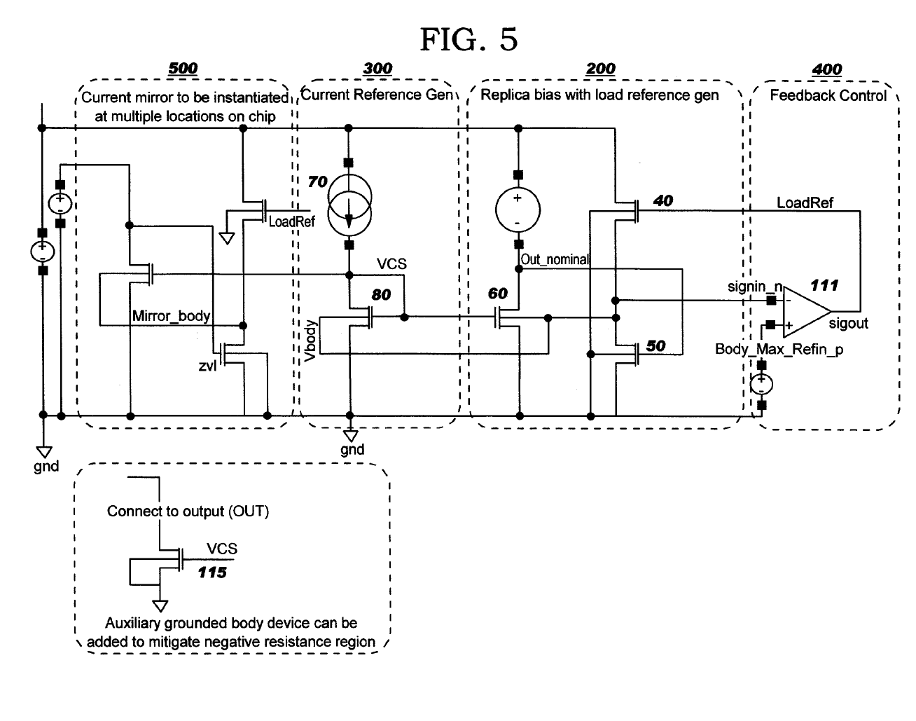

Referring to FIGS. 5-7, a schematic and a set of simulations according to a third embodiment of the body-biased enhanced current mirror are shown. In FIG. 5, a second current mirror instance 500 is coupled in parallel to the circuit of FIG. 3. The output current of NFET current mirror device 60 can be made to be decreasing monotonic over the range of interest of its drain voltage by varying the size of the transistors in the mirror reference voltage feedback path. By changing the aspect ratios, and hence the gain in the feedback path, of some of the transistors, the non-monotonic response of the current output may be emphasized or inhibited. More importantly, the non-monotonic behavior of the circuit can be controlled through transistor sizing, so that an optimal response is realized for the body-biased enhanced current mirror.

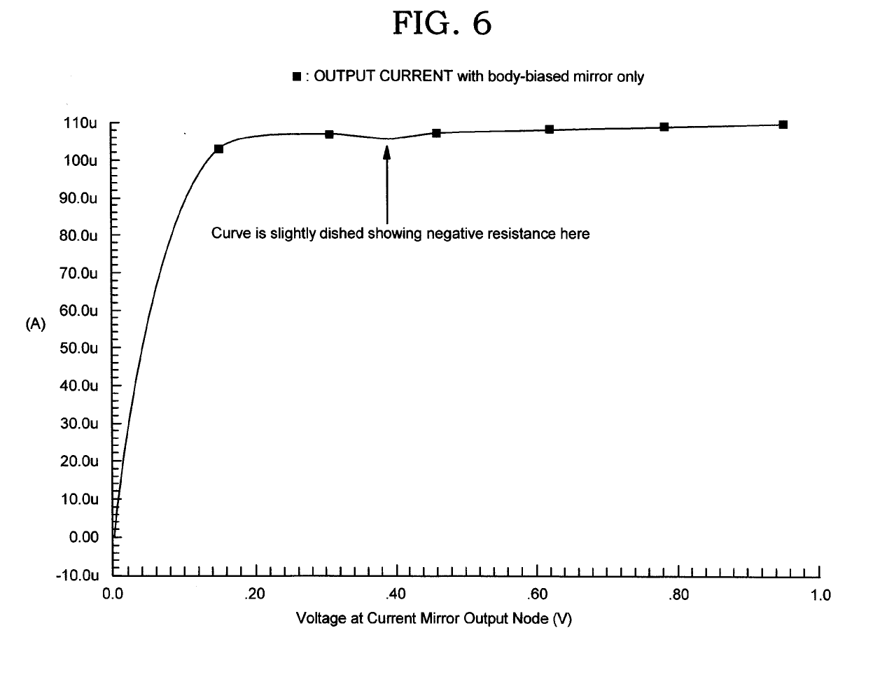

FIG. 5 shows a body-biased enhanced current mirror circuit schematic according to a third embodiment, wherein an auxiliary NFET current mirror device 115 is added with the body connected to ground as in the unmodified current mirror. The simulation plot shown in FIG. 6 reveals a monotonic current response measured at the drain of body-bias enhanced NFET current mirror device 60. Here, the auxiliary NFET current mirror device 115 helps to negate some component of the non-monotonic tendency caused by the primary NFET current mirror device 60. The circuit shown in FIG. 5 was optimized by decreasing the size of the primary (body-biased) mirror device by approximately the same amount as the width of the auxiliary device.

FIG. 6 shows a DC analysis simulation of voltage and current for the body-biased enhanced current mirror at the drain of NFET current mirror device 60. While still not optimal, a decrease in the non-monotonicity of the circuit response is observable for the current into the drain of NFET current mirror device 60. The monotonicity of the output response is mitigated by adding an auxiliary grounded body mirror device 115 and biasing its gate with the same potential as is used for the body-biased device 80.

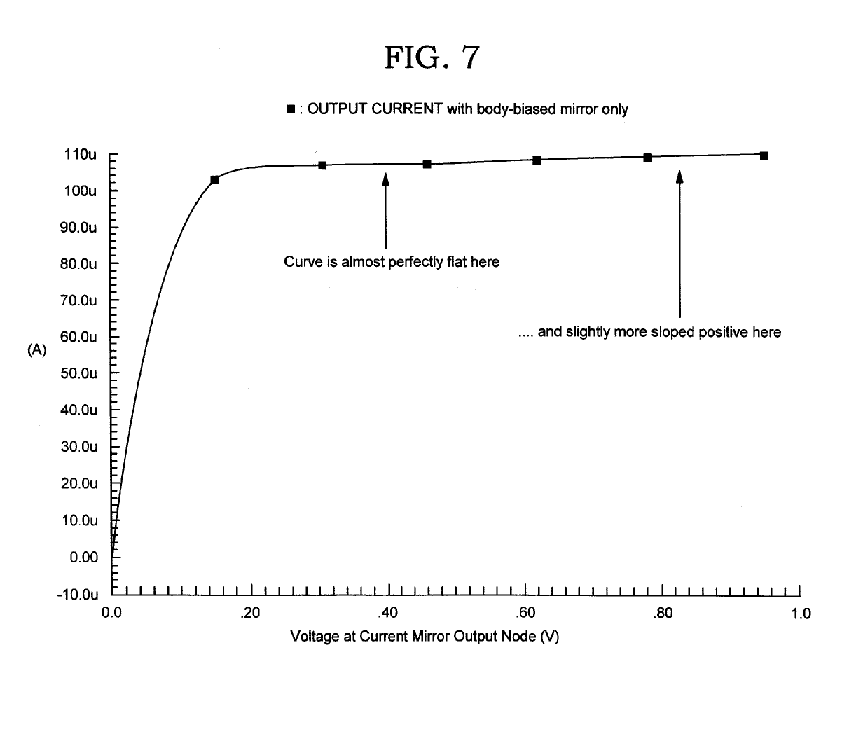

FIG. 7 depicts a simulation plot of the output of NFET current mirror device 60 according to the third embodiment of the invention, wherein the current flowing into the drain of the body-biased enhanced NFET current mirror device 60 exhibits a decrease in the non-monotonicity of response compared with the simulation shown in FIG. 6. The output response for the body-biased current mirror with an auxiliary device having a grounded body provides a nearly flat and slightly positively sloped response as compared to the output of the body-biased current mirror without the auxiliary device. The effects of negative resistance are mitigated with precise control of the aspect ratios of the transistors in the current mirror circuit and by adding the auxiliary device with grounded body as shown in FIG. 5., such that a near optimal response is realized.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A body-biased current mirror circuit, comprising:
a current reference generator capable of supplying a first current to the current mirror circuit;
a biasing circuit capable of dynamically adjusting a threshold voltage of a first output device of the current mirror circuit through modulation of a body voltage of the first output device such that an essentially constant output is realized for the current mirror; and
a feedback control circuit coupled to the biasing circuit.

2. The body-biased current mirror circuit according to claim 1, wherein the biasing circuit further comprises:
a replica bias circuit with load reference generator coupled to the current reference circuit, the replica bias circuit with load reference generator incorporating a biasing scheme to modulate the threshold voltage of an output device of the current mirror.

3. The body-biased current mirror circuit according to claim 2, further comprising a plurality of replica bias circuit with load generator instances.

4. The body-biased current mirror circuit according to claim 2, wherein the replica bias circuit with load reference generator comprises:
a first current mirror device driven by a reference mirror voltage;
a current amplifier coupled to the current mirror device, the current amplifier configured to regulate a body voltage of the current mirror device as a function of an output voltage of the current mirror device; and
a load element coupled to the current amplifier and driven by a reference voltage.

5. The body-biased current mirror circuit according to claim 4, wherein the first current mirror device comprises:
a MOSFET having a body potential set to a maximum desired value to prevent forward biasing of a body-to-diffusion junction of the MOSFET.

6. The body-biased current mirror circuit according to claim 4, wherein the current amplifier comprises a MOSFET configured to regulate a body voltage of the first current mirror device.

7. The body-biased current mirror circuit according to claim 4, wherein the current amplifier comprises a zero-threshold voltage MOSFET.

8. The body-biased current mirror circuit according to claim 4, wherein the current amplifier comprises a low-threshold voltage MOSFET.

9. The body-biased current mirror circuit according to claim 4, wherein the feedback control circuit comprises an operational amplifier having an output coupled to the load element, a first input node coupled to the first current mirror device and the current reference generator, and a second input coupled to the reference voltage.

10. The body-biased current mirror circuit according to claim 9, wherein the reference voltage corresponds to a specified forward bias voltage for the source body diode.

11. The body-biased current mirror circuit according to claim 10, wherein the maximum bias voltage is distributed through a grid based interconnect structure.

12. The body-biased current mirror circuit according to claim 4, wherein the first current mirror device comprises a MOSFET having a body voltage regulated by a load reference voltage.

13. The body-biased current mirror according to claim 4, wherein the current amplifier comprises a MOSFET that controls a body voltage of the first current mirror device.

14. The body-biased current mirror according to claim 4, wherein the load element comprises a MOSFET having a gate voltage regulated by a load reference voltage.

15. The body-biased current mirror according to claim 6, further comprising an array of replica bias circuit with load reference generator instances coupled to a single current reference generator and coupled to a single feedback control circuit.

16. The body-biased current mirror according to claim 1, wherein the current reference generator comprises:
a current source; and
a diode-connected MOSFET reference transistor coupled to the current source, the diode-connected MOSFET reference transistor having a body voltage regulated by a load reference voltage.

17. A method of implementing a current mirror integrated circuit with body-bias control, the method comprising:
monitoring an output voltage of the current mirror with a MOSFET amplifier;
compensating for modulation in an output voltage of the current mirror by regulating a body bias voltage of the current mirror, wherein:
the body bias voltage is lowered to increase a threshold voltage of the current mirror to offset the tendency of the mirror current to increase, thereby increasing an output impedance of the current mirror.

18. A method of implementing a body-biased current mirror circuit, the method comprising:
providing a current reference circuit capable of supplying a reference current to the current mirror circuit;
providing a biasing circuit capable of dynamically adjusting a threshold voltage of a first output device of the current mirror circuit through modulation of a body voltage of the first output device such that an essentially constant output is realized for the current mirror; and
providing a feedback control circuit.

19. The method according to claim 18, wherein the biasing circuit further comprises:
a replica bias circuit with load reference generator coupled to the current reference circuit, the replica bias circuit with load reference generator incorporating a biasing scheme to modulate the threshold voltage of an output device of the current mirror.

20. The method of according to claim 19, further comprising:
providing a first current mirror device within the replica bias circuit with load reference generator, the first current mirror device driven by a reference mirror voltage;
configuring a current mirror amplifier within the replica bias circuit with load reference generator to regulate a body voltage of the current mirror device as a function of an output voltage of the current mirror device; and
driving a load element coupled to the current amplifier with a reference voltage.
